(19) United States
(12) Patent Application Publication
(10) Pub. No.: US 2025/0244508 A1
(43) Pub. Date: Jul. 31, 2025

(54) DISAPPEARING CORROSION PREVENTION COATING

(71) Applicant: The Aerospace Corporation, El Segundo, CA (US)

(72) Inventors: Rafael J. Zaldivar, Redondo Beach, CA (US); Geena L. Ferrelli, Marina Del Rey, CA (US); Kelsey A. Folgner, Redondo Beach, CA (US); Peter D. Fuqua, Redondo Beach, CA (US); Hyun I. Kim, Brea, CA (US)

(21) Appl. No.: 18/427,166

(22) Filed: Jan. 30, 2024

(51) Int. Cl. G02B 1/18; C03C 17/30; C03C 17/32; C03C 17/42; C09D 5/08; C09D 183/08; G02B 5/08

(52) U.S. Cl. CPC G02B 1/18; C03C 17/30; C03C 17/32; C03C 17/42; C09D 5/08; C09D 183/08; G02B 5/08; C03C 2217/78

(57) ABSTRACT

A coating may include a self-assembled monolayer (SAM) of an organic molecule including a polar head group and a hydrophobic tail group. The polar head group is configured to attach to an underlying metal or ceramic surface. The SAM is configured to disintegrate upon exposure to high-energy radiation without reacting with the underlying surface.

### TECHNICAL FIELD

This application relates generally to corrosion prevention coatings, and more particularly, to corrosion prevention coatings for reflecting surfaces such as mirrors.

### BACKGROUND

Mirrors used in critical applications such as, for example, in space telescopes, are typically made by coating a substrate with a layer of silver because of its high reflectivity. However, such silver coated mirrors are prone to surface degradation because of corrosion when exposed to atmosphere, e.g., because of moisture and gases such as hydrogen sulfide, chlorine, nitrogen dioxide, etc.

To prevent such corrosion, silver mirrors can be coated with various protective layers on top of the silver layer. The overcoat layers are typically thin layers of metal oxides, nitrides or fluorides. Various materials, including SiO₂, SiO, Al₂O₃, HfO₂, Ta₂O₅, Si₃N₄, MgF₂ and YF₃ have been used as single layers or multilayer stacks to maximize durability. However, even with these protective layers, careful environmental control is necessary to avoid corrosion during long-term storage. Many of these coatings inherently have defects and pathways to corrosion. Corrosion studies have shown that the relative humidity is a key aspect of silver corrosion in addition to the presence of common corrosive pollutants in the atmosphere. These pollutants are believed to be ionized by humid air and infiltrate through the overcoat layer to cause corrosion in the silver layer. It is believed that eliminating moisture through low relative humidity is more effective in preventing silver corrosion that trying to reduce small amounts of trace pollutants. Therefore, completed silver mirrors are typically stored in a dry box at a low relatively humidity in addition to having protective overcoat layers.

Further, the dielectric materials used are not always compatible from a bond and stress point of view with the metal surface of the mirrors because of differences in thermal expansion coefficients. Indeed, some dielectrics may have built-in residual stresses in excess of 10,000 psi. These stresses have been shown to negatively impact corrosion resistance and uniformity. As a result, other solutions for protecting mirrors from corrosion are desired.

### SUMMARY

In one aspect of the present disclosure, a coating may include a self-assembled monolayer (SAM) of an organic molecule including a polar head group and a hydrophobic tail group. The polar head group is configured covalently to attach to an underlying metal or ceramic surface. The SAM is configured to disintegrate upon exposure to high-energy radiation without reacting with the underlying surface.

In another aspect of the present disclosure, a corrosion resistant mirror is provided. The mirror may include a reflecting surface, and a self-assembled monolayer (SAM) of an organic molecule including a polar head group and a hydrophobic tail group disposed on the reflecting surface.

In yet another aspect of the present disclosure, a method for protecting a reflecting surface of a mirror is provided. The method may include disposing a self-assembled monolayer (SAM) of an organic molecule including a polar head group and a hydrophobic tail group on the reflecting surface of the mirror. The SAM is transparent to visible light and configured to disintegrate upon exposure to high-energy radiation without reacting with the reflecting surface of the mirror.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates the process of corrosion of a silver mirror despite the presence of a protection layer.

FIG. 2A is a schematic of a SAM coating disposed on a dielectric surface protecting a silver layer of a silver-coated mirror, in accordance with some embodiments of the present disclosure.

FIG. 2B shows the effect of depositing the SAM, in accordance with some embodiments of the present disclosure, on the ceramic overcoat layer on the contact angle with water.

FIG. 3 shows a flow chart for a method for disposing a SAM on a glass substrate, in accordance with some embodiments of the present disclosure.

FIG. 4A shows an image, obtained using an atomic force microscope (AFM), of the surface of a glass mandrel coated with the primary coating material using the method described herein following step 350 of FIG. 3.

FIG. 4B shows an image, obtained using an AFM, of the surface of the same glass mandrel following the application of the secondary coating material and curing using the method described herein following step 380 of FIG. 3.

FIG. 5A shows the characteristics of a silver mirror having a ceramic overcoat layer after an extended MFG test.

FIG. 5B shows the characteristics of a silver mirror having a SAM coating in addition to the ceramic overcoat layer following an extended MFG test.

FIG. 6 shows the results of space environmental effects (SEE) testing of the SAM-coated mirrors performed to evaluate the effects of radiation in space on the SAM coating, in accordance with some embodiments of the present disclosure.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

The drawings are not drawn to scale. In the various drawings, like reference numerals indicate like items, unless expressly indicated otherwise in the text.

In the following, various embodiments are described with respect to the claimed systems as well as with respect to the claimed methods. Features, advantages, or alternative embodiments herein can be assigned to the other claimed objects and vice versa. In other words, claims for the devices or apparatuses can be improved with features described or claimed in the context of the methods. In this case, the functional features of the method are embodied by objective units of the devices or apparatuses. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

As used herein, the term “about” is relative to the actual value stated, as will be appreciated by those of skill in the art, and allows for approximations, inaccuracies and limits of measurement under the relevant circumstances. In one or more aspects, the terms “about,” “substantially,” and “approximately” may provide an industry-accepted tolerance for their corresponding terms and/or relativity between items, such as a tolerance of from less than one percent to 10 percent of the actual value stated, and other suitable tolerances.

The present disclosure relates to corrosion prevention coatings, and in particular coatings for preventing corrosion of metal surfaces. One example of a metal surface that needs protection from corrosion is a mirror. While the corrosion prevention mirrors disclosed herein can be used to protect any metal surface, the disclosure that follows will use silver-coated mirrors as an example of a surface that can be protected using the corrosion prevention coatings disclosed herein. Those of ordinary skill in the art, upon understanding the details provided in the present disclosure will be able to suitably modify the corrosion prevention coatings for protecting other types of metal surfaces as desired.

Silver-coated mirrors are commonly used in space applications such as, e.g., optics for a space telescope or reflectors on a satellite, because of the excellent reflectivity of silver. However, during the storage of these mirrors prior to launch even the most controlled environments result in silver corrosion resulting in tarnishing and a degradation of optical performance. When this occurs, extremely costly measures are necessary to re-strip the entire optics, sometimes requiring disassembling the composite structural assembly. Scientists throughout the years have developed numerous special dielectric or ceramic coatings to slow this corrosion, however they do not always eventually prevent this corrosion. There are inherent limitations of ceramic coatings on mirrors in terms of the ability to protect the mirrors from corrosion because of pinholes and other defects in the ceramic coatings.

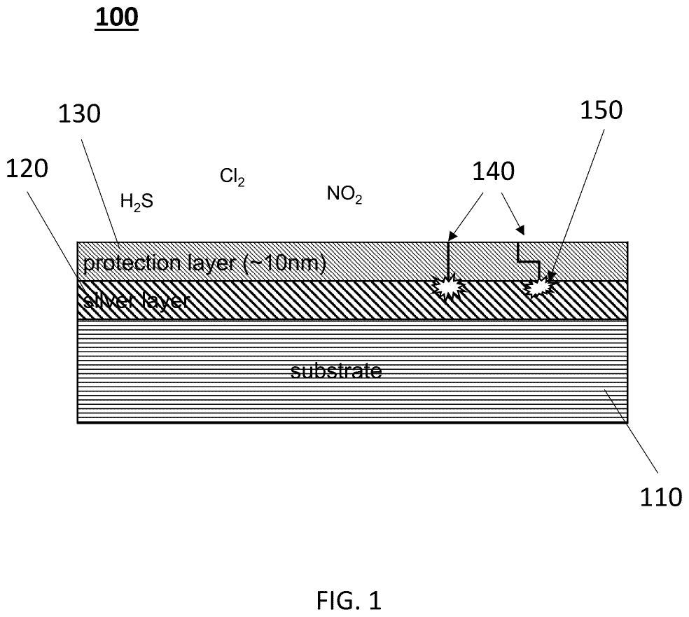

FIG. 1 illustrates the process of corrosion of a silver mirror despite the presence of a protection layer. A typical silver mirror 100 includes a substrate 110 on which a silver layer 120 is coated. Conventionally, the silver mirror 100 is protected by depositing a ceramic layer 130 over the silver layer 120 as a protection layer. The ceramic material typically used as protection layer include, but are not limited to, SiO₂, SiOₓ, Al₂O₃, HfO₂, Ta₂O₅, Si₃N₄, MgF₂ and YF₃. Most of these ceramic materials are hydrophilic, and thus, significant adsorption of moisture and solvated ions occurs on the surface of such coatings.

A typical mirror such as one used for space telescopes or other space applications can have diameters ranging from a few millimeters to several tens of centimeters or even larger, obtaining a thin ceramic coating layer without compromising on the reflectivity of the mirror surface is extremely challenging. In particular, obtaining such a coating with zero defects with even more difficult. Consequently, the protection layer 120 inherently includes pinholes and defects 140. Further, there is a substantial difference in the coefficient of thermal expansion of the ceramic layer and the underlying silver layer. This difference can induce substantial stress on the protection layer even for minor temperature changes during storage and use, resulting in defects such as pinholes 140. In presence of such pinholes 140, the adsorbed water provides a medium through which the solvated ions can migrate across the surface of the ceramic coating. The solvated mobile ions eventually penetrate through defects and pinholes in the ceramic coating layer and come in contact with the underlying metal (e.g., silver) of the mirror and promote corrosion 150.

As a result, additional or alternative coatings on mirrors are required for preventing corrosion when exposed to atmosphere. The presently disclosed corrosion prevention coatings stem from the realization that providing hydrophobic coatings either directly on the silver surface or on the ceramic surface protecting the silver surface is useful in preventing adsorption of water on the mirror surface, thereby preventing the penetration of the corrosion inducing compounds, radicals and ions. Accordingly, in one aspect of the present disclosure, a coating that can prevent corrosion of a surface, e.g., that of a mirror, is provided. In some embodiments, the coating includes a self-assembled monolayer (SAM) of an organic molecule including a polar head group and a hydrophobic tail group. The polar head group is configured to covalently attach to an underlying metal or ceramic surface.

Advantageously, while a typical hydrophobic coating may be several microns thick and can adversely affect the optical performance of the mirror, a SAM coating, such as disclosed herein, is only a few nanometers thick, is self-limiting in size based on its chemical structure, and thus does not have any negative impact on the optical performance of the mirror.

Further, because the SAM coatings are extremely compliant, there is negligible stress induced on the underlying layer from deposition of the SAM coatings. Moreover, the SAM coatings disclosed herein can be reliably provided on a surface of any size using the various methods disclosed herein. Consequently, the SAM coatings of the present disclosure can be used for protecting the surfaces of mirrors such as, for example, space mirrors, for which the size may range from several millimeters to several meters in diameter.

Further advantageously, the SAM coatings of the present disclosure are transparent to visible light, and therefore, may be used to protect mirror surfaces without adversely affecting the optical performance of the mirrors. In addition, the organic molecules of the SAM coating can be selected such that the SAM coating disintegrates upon exposure to high-energy radiation occurring in outer space without reacting with the underlying surface. Thus, while the SAM coating can effectively protect the mirror surface while on earth, any potential negative effect on optical performance of the mirror can be further mitigated as the SAM coating disintegrates and disappears once the mirror is deployed in space. In particular, the head group of the organic molecule of the SAM, that interacts with the underlying metal or dielectric surface, is selected to disintegrate without not reacting with the material of the underlying surface.

High-energy radiation as used herein refers to radiation in outer space does not typically penetrate the earth's atmosphere and may include ultraviolet (UV) radiation, deep UV radiation, extreme UV radiation, X-rays, gamma radiation, ionizing particles such as α- and β-particles, and the like.

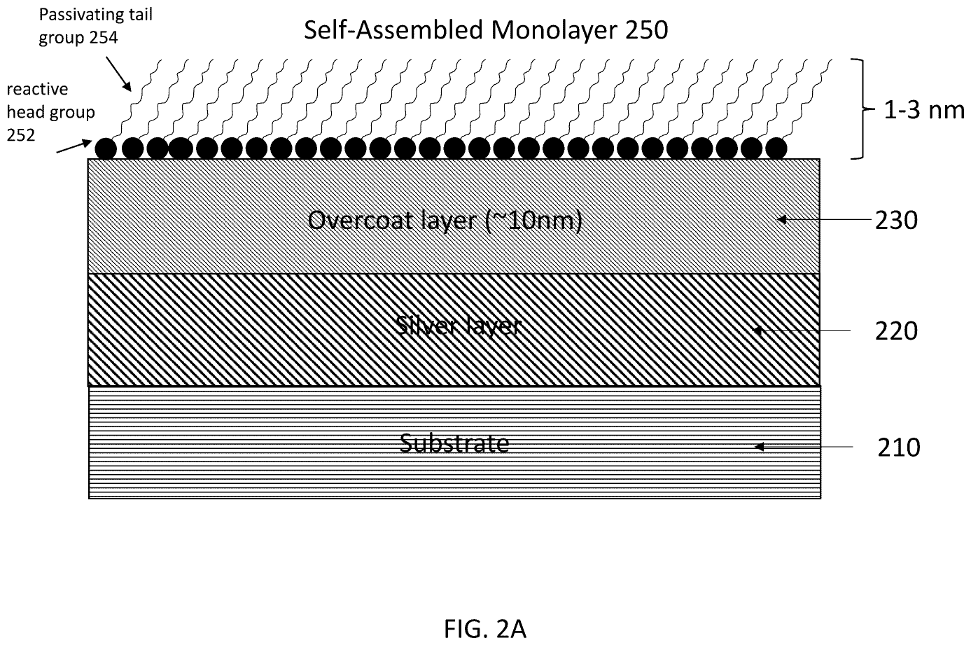

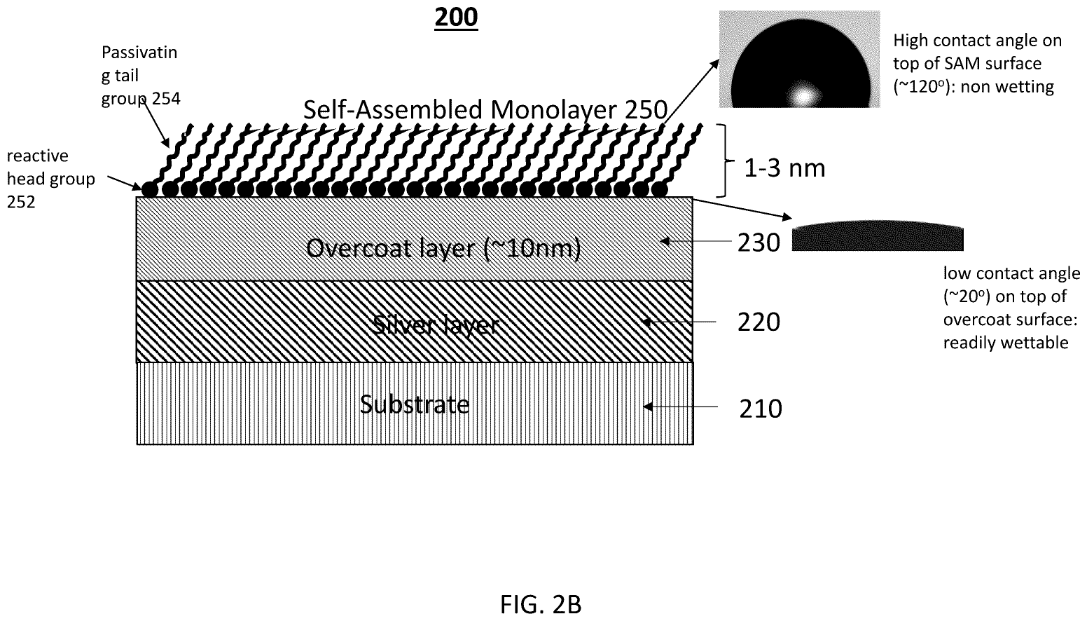

FIG. 2A is a schematic of a SAM coating disposed on a dielectric surface protecting a silver layer of a silver-coated mirror, in accordance with some embodiments of the present disclosure. A silver-coated mirror 200 include a substrate 210, a silver layer 220, and a overcoat (or protection) layer 230. The SAM 250 is disposed on the overcoat layer 230.

The substrate 210 may be any material including, but not limited to, a ceramic, glass or any other suitable dielectric material so long as it is compatible with deposition of silver and provides good adhesion to the silver layer 220. The thickness of the substrate 210 is generally dependent on the specific application for which it is used, and may, therefore, depend on factors such as the desired reflective surface area of the mirror 200.

The thickness of the silver layer 220 is not particularly limited so long as the coverage of the silver layer 220 on the substrate 210 is uniform and the silver layer 220 is defect-free. Thus, for example, the thickness of the silver layer 220 may range from about 10 nm to about 500 μm. In some embodiments, the thickness of the silver layer 220 may be higher than 500 μm. Depending on the specific application, the silver layer 220 may preferably have ultra-low roughness and high uniformity. Thus, in some embodiments, the silver layer 220 may have a roughness on the order of 10s of Angstrom, and flatness of less than λ/4, preferably λ/10, where λ is the wavelength of the radiation it is designed to reflect.

Those of skill in the art would readily recognize that while the present disclosure uses silver as the material for the reflective layer of a mirror, other suitable materials may also be used. Silver is being used herein as an example because it is the most commonly used reflective material for mirror applications. However, the scope of the present disclosure is not limited thereto, and those of skill in the art, upon understanding the present disclosure, will be able to suitably modify the coating disclosed herein even if a different reflective material is used.

Thickness of the overcoat layer 230 is not particularly limited, but is preferably limited to a thickness that will not deteriorate the optical performance of the mirror 200. Thus, in some embodiments, the thickness of the overcoat layer 230 is in the range from about 1 nm to about 50 nm. The particular thickness selected for the overcoat layer 230 is based on the trade-off between the number of potential defects in the overcoat layer 230 and the deterioration in the optical performance. For example, if the overcoat layer 230 is too thin, the number of defects such as pinholes per unit area is generally larger. On the other hand, if the overcoat layer 230 is too thick, the reflectivity of the optical mirror may be decreased, thereby adversely affecting the optical performance of the mirror.

In some embodiments, the overcoat layer 230 may be absent.

Likewise, the material of the overcoat layer 230 is not particularly limited so long as it does not deteriorate optical performance and can be deposited at a desired thickness with minimal defects. Some examples of the material for the overcoat layer 230 include, but are not limited to, SiO₂, SiOₓ, Al₂O₃, HfO₂, Ta₂O₅, Si₃N₄, MgF₂, ZrO₂, Carbon (tetrahedral) and YF₃. Other suitable materials may also be used. For example, a suitable material for the overcoat layer 230 is one that is transparent to visible light.

The SAM 250 includes a reactive head group 252, and a passivating tail group 254. The reactive head group 252 is selected to react with the overcoat layer 230 such that the SAM 250 has a strong adhesion to the overcoat layer 230. Thus, the reactive head group 252 is selected based on the material of the overcoat layer 230. Some examples of the head group 252 include, but are not limited to, carboxyl, hydroxyl, acrylate, sulfate, phosphate, trimethoxysilane, triethoxysilane, trichlorosilane, and thiol.

The passivating tail group 254 is a hydrophobic chain group such as, for example, a long-chain hydrocarbon or a long-chain fluorocarbon. In some embodiments, the passivating tail group 254 is a linear hydrocarbon or a linear fluorocarbon. In some embodiments, the passivating tail group 254 is a branched hydrocarbon or a branched fluorocarbon. One example of a suitable passivating tail group 254 is perfluoropolyether (PFPE).

The passivating tail group 254, in some embodiments, has a length in a range from 8 to 20 carbons. The length of the passivating tail group 254 is selected depending on the particular method used for disposing the passivating tail group 254, which may in turn, be dependent on the surface area of the underlying surface on which the SAM 250 is to disposed.

Thus, for example, depending on the surface area of the underlying substrate, the SAM 250 may be disposed using a gas phase method or a solution deposition method. In embodiments where a gas phase method is used for disposing the SAM 250, the length of the passivating tail group 254 is generally shorter, and in embodiments where a solution deposition method is used, longer passivating tail groups may be used.

In some embodiments, the SAM 250 may include two or more different coatings, each having different chain lengths so as to further minimize potential defects. Thus, in some embodiments, the SAM 250 includes a primary coating, e.g. with longer length passivating tail groups, and one or more secondary coatings, e.g., with shorter length passivating tail groups that can fill any gaps or pinholes left in the primary coating.

An example of the organic molecule used for forming the SAM 250 is a PFPE with a trimethyoxysilane functional head group on one end of the polymer chain. Such a molecule may have a general molecular represented by R—(CF₂CF₂CF₂O)ₙ—Si(CH₃)₃ and a molecular weight in a range from about 2000 to about 7000, where R is suitably selected to provide high hydrophobicity to the SAM upon deposition. The molecule may have one or more trimethoxysilane terminating groups. Such a molecule can be used when the overcoat layer is a oxide, a fluoride, a nitride, or any other suitable dielectric material. In some embodiments, the dielectric material is silicon dioxide disposed on a silver mirror.

FIG. 2B shows the effect of depositing the SAM on the ceramic overcoat layer on the contact angle with water. As can be seen in FIG. 2B, the hydrophobic SAM coating results in a contact angle of greater than 90° (for example, about) 120° indicating that the SAM coated surface is non-wetting, as compared to a contact angle of about 20° or lower on the ceramic overcoat layer indicating that the overcoat layer is readily wettable.

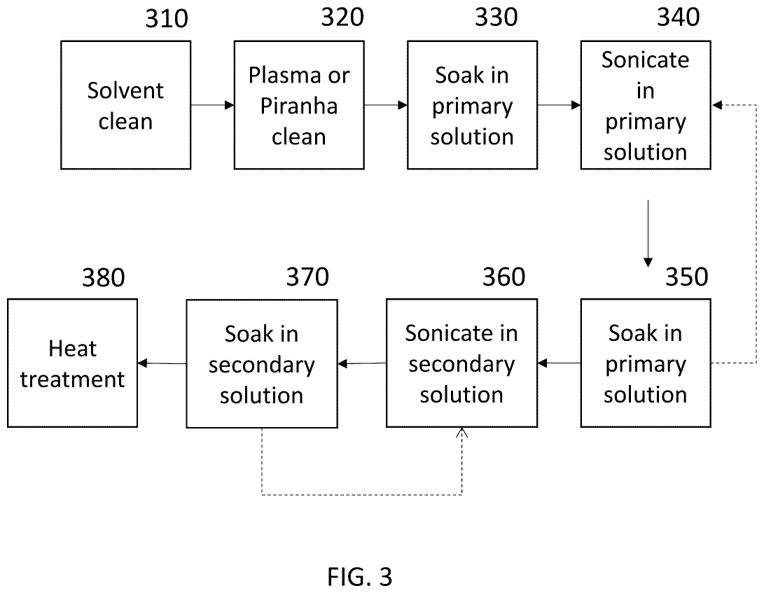

FIG. 3 shows a flow chart for a method for disposing a SAM on a glass substrate, in accordance with some embodiments of the present disclosure. The method involves cleaning the surface of the glass followed by soaking the glass in a solution comprising the organic molecule that forms the SAM. While the description that follows uses glass as the substrate for demonstrating the ability to dispose a uniform SAM, those of skill in the art would recognize that the method can be used for depositing uniform SAMs on any suitable substrate including, but not limited to, a mirror that has an overcoat protection layer on the reflective metal surface of the mirror.

The method includes, at 310, sonicating the substrate surface in cleaning solvent such as, but not limited to, acetone and isopropyl alcohol. The sonication in presence of acetone and isopropyl alcohol may be performed as separate steps in some embodiments. The amount of time for which sonication is performed is not particularly limited. Thus, for example, the substrate may be sonicated for a period of time ranging from about 1 minute to about 1 hour. Acetone and isopropyl alcohol being organic solvents, the sonication at 310 is useful for removing any organic materials such as, e.g., oils, that may be disposed on the surface of the substrate. In some embodiments, the substrate is then dried under flowing inert (e.g., nitrogen or argon) gas.

At 320, the glass surface is further cleaned to ensure more complete removal of surface contaminants. One can use a piranha solution, which is a mixture of sulfuric acid and hydrogen peroxide (with a typical ratio ranging from about 3:1 to about 7:1). Exposure to the piranha solution is useful for removing any inorganic materials that may be disposed on the substrate surface that could not be removed by the organic solvents. In some embodiments, the substrate is then rinsed with water, preferably deionized water, and dried under flowing inert (e.g., nitrogen or argon) gas. One may also use plasma treatment to remove minute amount of surface contaminants. Depending on the nature of the substrate, one may utilize vacuum plasma or atmospheric plasma with appropriate active gases including, for example, oxygen, nitrogen and/or hydrogen. In case of plasma cleaning, no water rinse is necessary.

Once cleaned, the substrate is, at 330, soaked in a primary solution comprising the organic material of the primary coating material for the SAM. In addition to the primary coating material, the primary solution may include a primary solvent such as, for example, a fluorocarbon, although the solvent is not limited thereto.

The primary coating material may be any organic molecule that can form a SAM as discussed herein. For example, in some embodiments, the primary coating material may include a reactive head group 252 and a passivating tail group 254. In some embodiments, the passivating tail group for the primary coating material may be selected to have a chain length ranging from about 8 carbons to about 20 carbons, or ranging from about 8 nm to about 20 nm.

Thus, in some embodiments, the passivating tail group of the primary coating material may have a chain length of about 8 carbons, about 9 carbons, about 10 carbons, about 11 carbons, about 12 carbons, about 13 carbons, about 14 carbons, about 15 carbons, about 16 carbons, about 17 carbons, about 18 carbons, about 19 carbons, about 20 carbons, about 21 carbons, about 22 carbons, about 23 carbons, about 24 carbons, about 25 carbons, about 26 carbons, about 27 carbons, about 28 carbons, about 29 carbons, or about 30 carbons. The passivating tail group of the primary coating material may be linear or branched.

The amount of time for which the substrate is soaked is not particularly limited and can be optimized to ensure uniform and defect-free coverage of the SAM. Thus, the amount of time for which the substrate is soaked in the primary solution is may depend on factors such as, for example, the particular primary coating material, the solvent in the primary solution, the material of the substrate and the size of the substrate. In some embodiments, the substrate is soaked in the primary solution for a period of time ranging from about 1 minute to about 1 hour. Thus, the substrate may be soaked in the primary solution for about 1 minute, about 2 minutes, about 5 minutes, about 10 minutes, about 15 minutes, about 20 minutes, about 25 minutes, about 30 minutes, about 35 minutes, about 40 minutes, about 45 minutes, about 50 minutes, about 55 minutes, about 60 minutes or any amount of time between any two of these times.

In some embodiments, the method may include, at 340, sonicating the primary solution while the substrate is being soaked. Thus, for example, ultrasound vibrations may be applied to the solution while the substrate is being soaked in the primary solution. The amount of time for which sonication is performed at 340 is not particularly limited and may range from about 1minute to about 1 hour. In some embodiments, the substrate is sonicated for about 1 minute, about 2 minutes, about 5 minutes, about 10 minutes, about 15 minutes, about 20 minutes, about 25 minutes, about 30 minutes, about 35 minutes, about 40 minutes, about 45 minutes, about 50 minutes, about 55 minutes, about 60 minutes or any amount of time between any two of these times.

Without wishing to be bound by theory, the sonication of the substrate in the primary solution may help increase the order and density of the SAM coating. In some embodiments, the sonication may be followed by, at 350, a second soak of the substrate in the primary solution. Like the soak at 330, the amount of time for which the substrate is soaked is not particularly limited and can be optimized to ensure uniform and defect-free coverage of the SAM. In some embodiments, the second soak may be performed a period of time ranging from about 1 minute to about 1 hour. Thus, in some embodiments, the second soak may be performed for about 1 minute, about 2 minutes, about 5 minutes, about 10 minutes, about 15 minutes, about 20 minutes, about 25 minutes, about 30 minutes, about 35 minutes, about 40 minutes, about 45 minutes, about 50 minutes, about 55 minutes, about 60 minutes or any amount of time between any two of these times. In some embodiments, the second soak at 350 is optional. In some embodiments, the sonication at 340 may be repeated after the second soak 350.

Following the deposition of the primary coating material, a secondary coating material may be added to the SAM so as to fill in any gaps and pinholes in the SAM formed by the primary coating material. At 360, the substrate having the SAM with the primary coating material is soaked and sonicated in a secondary solution comprising a secondary coating material. In addition to the secondary coating material, the secondary solution may include a secondary solvent such as, for example, a fluorocarbon, although the secondary solvent is not limited thereto.

The secondary coating material has shorter chain length to facilitate diffusion between the long chains of the primary coating material that is already disposed on the substrate surface. The secondary coating material may be any organic molecule that can form a SAM as discussed herein. For example, in some embodiments, the secondary coating material may include a reactive head group 252 and a passivating tail group 254 with shorter chain lengths than that of the passivating tail group of the primary coating material. In some embodiments, the passivating tail group for the secondary coating material may be selected to have a chain length ranging from about 5 carbons to about 15 carbons, or ranging from about 1 nm to about 5 nm. Thus, in some embodiments, the passivating tail group of the secondary coating material may have a chain length of about 5 carbons, about 6 carbons, about 7 carbons, about 8 carbons, about 9 carbons, about 10 carbons, about 11 carbons, about 12 carbons, about 13 carbons, about 14 carbons, or about 15 carbons. The passivating tail group of the secondary coating material may be linear or branched. One example of the secondary coating material is 1H, 1H,2H,2H-perfluorooctyltriethoxysilane (POTS), which is a short chain fluorocarbon with tryethoxysilane terminal groups.

Without wishing to be bound by theory, sonicating the secondary solution at 360 may facilitate diffusion of the molecules of the secondary coating material through the SAM formed by the primary coating material and may also displace weakly adsorbed agglomerates of the primary coating material.

After sonication, at 370, the substrate is allowed to soak in the secondary solution for a period of time, e.g., ranging from about 1 minute to about 1 hour, to allow the freshly infused molecules of the secondary coating material to chemically bond to the substrate surface. In some embodiments, 360 and 370 are repeated with the same secondary coating material. In some embodiments, 360 and 370 repeated using a different secondary coating material.

The substrate is then removed from the secondary solution and, at 380, heated to cure the SAM. The curing temperature is not particularly limited, and may be in a range from about 50° C. to about 150° C. The curing temperature may depend on factors such as, for example, the material of the substrate, the primary coating material, the secondary coating material, presence of a third coating material, presence of an overcoat layer between the substrate and the SAM, and the like. Those of skill in the art, upon understanding the present disclosure, will be able to optimize the curing temperature such that the SAM is reinforced and the adhesion between the substrate surface and the SAM is increased without damaging or degrading the SAM.

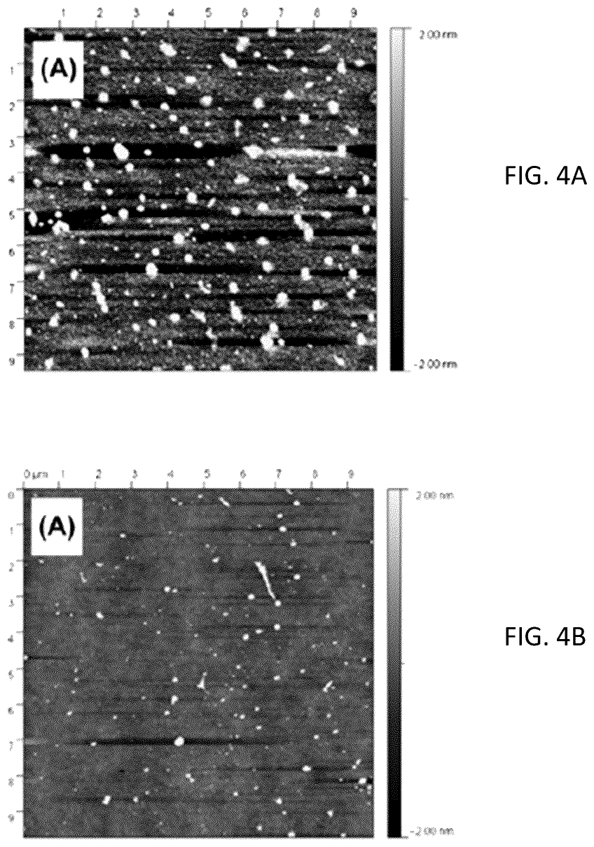

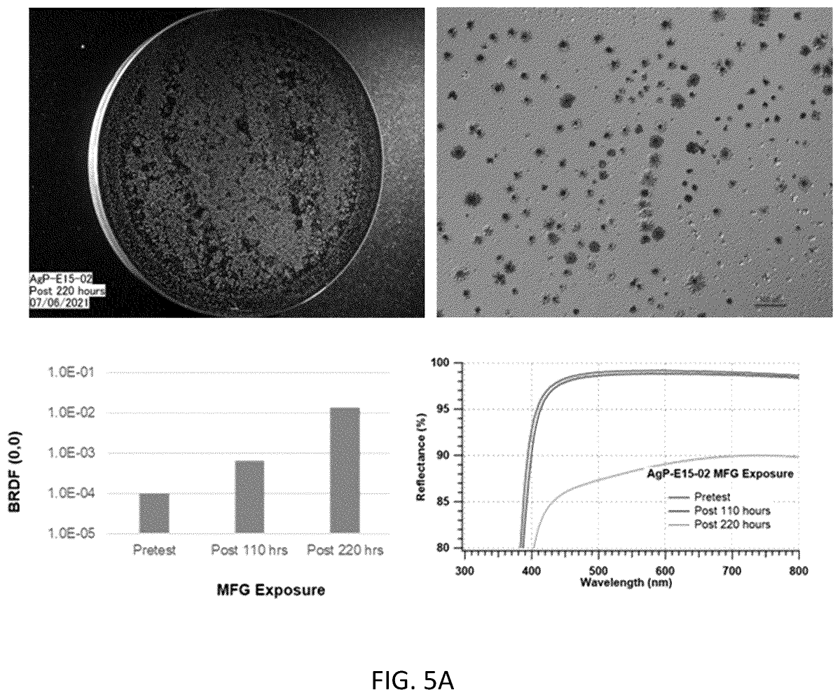

Without wishing to be bound by theory, a properly deposited SAM is helpful in reducing the surface roughness of the substrate surface. FIG. 4A shows an image, obtained using an atomic force microscope (AFM), of the surface of a glass mandrel coated with the primary coating material using the method described herein following step 350. FIG. 4B shows an image, obtained using an AFM, of the surface of the same glass mandrel following the application of the secondary coating material and curing using the method described herein following step 380. An Agilent Technologies 5500 AFM was used for imaging. Ti-coated Si tip/cantilevers were used to obtain topographic images in full contact mode. The spring constant was 0.6 N/m. Samples were scanned over a 10 μm×10 μm area. As can be seen in FIG. 4A, the primary coating may result in some amount of agglomerates, thereby increasing the overall surface roughness. However, following the sonication process and deposition of the secondary coating material at 360 and 370, the surface roughness is reduced substantially. Table 1 provides a summary of the RMS roughness values as obtained by the AFM.

TABLE 1
Summary of the AFM roughness measurement. Monolayer area
represents the area between the nodules seen in FIG. 4A.

| | Entire image | Monolayer area |
|---|---|---|
| After step 350 | 3.9 | 0.5 |
| After step 380 | 0.6 | 0.1 |

In another aspect to the present disclosure, a mirror having a self-assembled monolayer disposed thereon is provided. The mirror may have a reflecting surface and a self-assembled monolayer (SAM) disposed on the reflecting surface. The SAM may be any SAM described herein and the SAM may be disposed on the reflecting surface using any of the methods described herein. In some embodiments, the SAM is transparent to visible light and is configured to disintegrate and disappear upon exposure to high-energy radiation without reacting with the reflecting surface of the mirror.

The reflective surface of the mirror may include a metal such as, for example, silver. Thus, the mirror may have a substrate and a reflective coating forming the reflecting surface. The reflective coating may be a suitable metal such as silver. The mirror may additionally have a protecting overcoat layer disposed between the SAM and the metal layer in some embodiments.

In some embodiments, the mirror may be used as a space mirror. In such embodiments, the SAM provides corrosion protection to the reflecting surface, and once the space mirror is deployed in space while in use, the SAM disintegrates and disappears upon exposure to the high-energy radiation encountered in space. The efficacy of the SAM in protecting the reflecting surface of the space mirror from corrosion was tested using an industry standard accelerated corrosion test also known as mixed flowing gas (MFG) exposure test.

MFG testing was developed in the 1980s as an accelerated environmental test to evaluate the reliability of electrical components and has more recently been applied to assess the durability of mirrors. MFG exposure was designed to simulate corrosion resulting from common atmospheric pollutants and evaluate the long-term behavior of materials in a shortened time frame. While other types of accelerated testing such as, for example, humidity exposure and salt fog exposure, may also be used to evaluate mirrors, MFG exposure has been considered a more realistic assessment of long-term behavior.

During the MFG test the mirrors were exposed to controlled concentrations of three known air pollutants, hydrogen sulfide (H₂S), chlorine (Cl₂), and nitrogen dioxide (NO₂), along with moisture at a constant relative humidity. The gases were diluted with purified air produced by a Parker Balston 76-98-N100 zero air generator and moisture was introduced into the gas flow by a bubbler. Specific test conditions followed the Battelle Laboratory MFG Test Methods Class II environment for testing electronic components (10 ppb H₂S, 10 ppb Cl₂, and 200 ppb NO₂ at 30° C. and 70% relative humidity). The Class II environment simulates an indoor environment, such as a business office or laboratory, that does not have effective or continuous environmental control. The mirror samples were tested for a total of 10 days (242 h), in increments of two to three days. It has been has shown that RF magnetron sputtered bare silver mirrors as well as those without adhesion layers, significantly degrade under these conditions.

Prior to, during, and after environmental testing, the mirror centers were characterized to observe changes in optical properties and film morphology. Reflectance was measured from 200 to 2500 nm with a Perkin-Elmer Lambda 950 spectrometer with an absolute reflectance accessory (URA). Scatter was measured with a Schmitt Measurement Systems (SMS) μ-scan scatterometer at 670 nm. This instrument measures the bidirectional reflectance distribution function (BRDF) at two angles to calculate an equivalent surface roughness from the measured scatter. A Keyence VHX-600 digital microscope was used under dark field conditions to highlight degradation on the entire mirror surface. A Nikon Eclipse LV100 optical microscope was used for higher magnification imaging of specific surface features under differential interference contrast (DIC) mode.

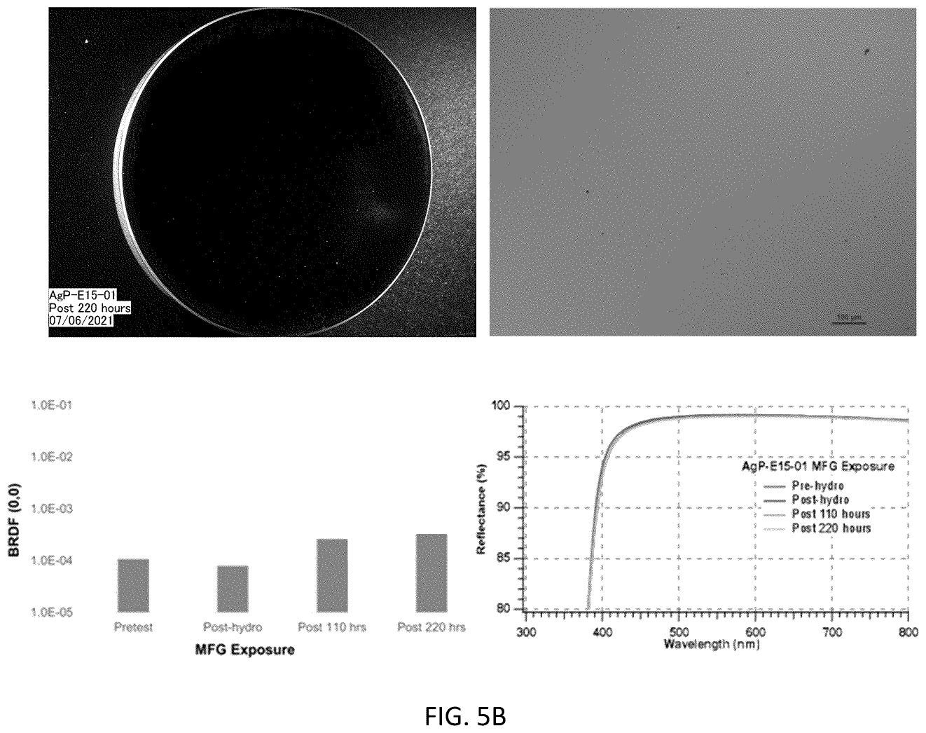

FIG. 5A shows the characteristics of a silver mirror having a ceramic overcoat layer after an extended MFG test. The photographs in FIG. 5A show the surface of the mirror. Microstructural pitting caused by the corrosion during the extended MFG test. The histogram in FIG. 5A shows corresponding increases in scatter data obtained using bidirectional distribution function (BRDF) before and after the MFG test. The line plot in FIG. 5A shows significant decrease in reflectivity after 220 hours of MFG exposure.

FIG. 5B shows the characteristics of a silver mirror having a SAM coating in addition to the ceramic overcoat layer following an extended MFG test. As can be seen in the photographs in FIG. 5B, no evidence of pitting or corrosion products is present on the SAM-coated mirror. Additionally, there is negligible change in scatter and no decrease in the reflectivity performance of the SAM-coated mirror following the same extended MFG exposure test as conducted for the uncoated mirror shown in FIG. 5A.

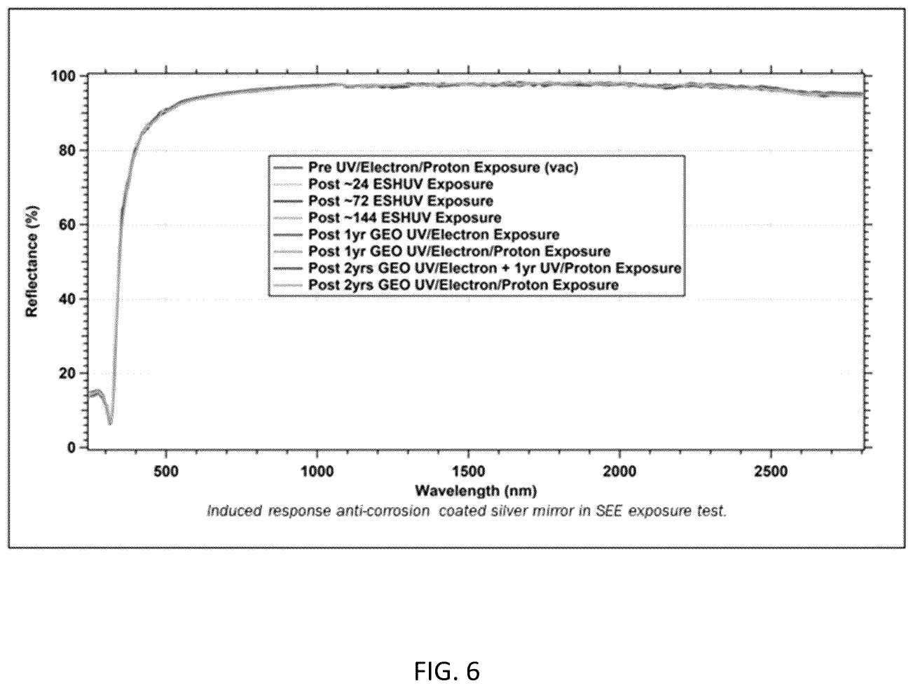

FIG. 6 shows the results of space environmental effects (SEE) testing of the SAM-coated mirrors performed to evaluate whether the SAM coating had any negative effect on the mirror's performance after two years of exposure to UV radiation, as well as electron and proton beams. The reflectance measurements as a function of this exposure are seen in FIG. 6. The data shows that the SAM coating had no negative impact on reflectivity performance. Further, X-ray photoelectron spectroscopy (XPS) indicated negligible atomic indications of the SAM coating after the SEE testing, indicating that the SAM coating had disappeared upon exposure to the high energy radiation during the SEE testing without having any adverse impact on the optical performance of the mirror.

Although the subject matter has been described in terms of exemplary embodiments, it is not limited thereto. Rather, the appended claims should be construed broadly, to include other variants and embodiments, which can be made by those skilled in the art.

What is claimed is:

1. A coating, comprising:
a self-assembled monolayer (SAM) of an organic molecule including a polar head group and a hydrophobic tail group, the polar head group being configured to covalently attach to an underlying metal or ceramic surface,
wherein the SAM is configured to disintegrate upon exposure to high-energy radiation without reacting with the underlying surface.

2. The coating of claim 1, wherein the SAM has a thickness of less than 10 nm.

3. The coating of claim 1, wherein the SAM is transparent to visible light.

4. The coating of claim 1, wherein the hydrophobic tail group comprises a primary tail group with a chain length of at least 15 carbons, and a secondary tail group having a chain length in a range from 5 to 15 carbons.

5. The coating of claim 1, wherein the hydrophobic tail group comprises a linear or branched hydrocarbon having at least 8 carbons.

6. The coating of claim 1, wherein the head group is selected from the group consisting of carboxyl, hydroxyl, acrylate, sulfate, phosphate, trimethoxysilane, triethoxysilane, trichlorosilane, and thiol.

7. The coating of claim 1, wherein the coating exhibits substantially no degradation upon accelerated corrosion testing using mixed flowing gas simulating at least two years of atmospheric environmental exposure.

8. The coating of claim 1, wherein the organic molecule comprises perfluoropolyether.

9. The coating of claim 1, wherein the organic molecule has a molecular weight of less than 5000.

10. A mirror comprising:
a reflecting surface; and
a self-assembled monolayer (SAM) of an organic molecule including a polar head group and a hydrophobic tail group, covalently attached to the reflecting surface.

11. The mirror of claim 10, wherein the SAM is transparent to visible light and configured to disintegrate and disappear upon exposure to high-energy radiation without reacting with the reflecting surface of the mirror.

12. The mirror of claim 10, wherein the SAM comprises a primary coating with the hydrophobic tail group having a chain length of at least 15 carbons, and a secondary coating with the hydrophobic tail group having a chain length in a range from 5 to 15 carbons.

13. The mirror of claim 10, further comprising a ceramic coating on the reflecting surface, the ceramic coating being transparent to visible light.

14. The mirror of claim 10, wherein the ceramic coating comprises a material selected from the group consisting of SiO₂, SiOₓ, Al₂O₃, HfO₂, Ta₂O₅, Si₃N₄, MgF₂ and YF₃.

15. The mirror of claim 13, wherein the ceramic coating has a thickness in a range from about 1 nm to about 50 nm.

16. The mirror of claim 10, wherein the head group is selected from the group consisting of carboxyl, hydroxyl, acrylate, sulfate, phosphate, trimethoxysilane, triethoxysilane, trichlorosilane, and thiol.

17. The mirror of claim 10, wherein the hydrophobic tail group comprises a linear or branched hydrocarbon having at least 8 carbons.

18. A method for protecting a reflecting surface of a mirror, the method comprising:
disposing a self-assembled monolayer (SAM) of an organic molecule including a polar head group and a hydrophobic tail group on the reflecting surface of the mirror,
wherein the polar head group is covalently attached to the reflecting surface, wherein the SAM is transparent to visible light and configured to disintegrate upon exposure to high-energy radiation without reacting with the reflecting surface of the mirror.

19. The method of claim 18, wherein the hydrophobic tail group comprises a primary tail group with a chain length of at least 15 carbons, and a secondary tail group having a chain length in a range from 5 to 15 carbons.

20. The method of claim 18, wherein the head group is selected from the group consisting of carboxyl, hydroxyl, acrylate, sulfate, phosphate, trimethoxysilane, triethoxysilane, trichlorosilane, and thiol.

21. The method of claim 18, further comprising coating the reflecting surface of the mirror with a ceramic coating prior to coating with the SAM.

22. The method of claim 18, the ceramic coating comprises a material selected from the group consisting of SiO₂, SiOₓ, Al₂O₃, HfO₂, Ta₂O₅, Si₃N₄, MgF₂ and YF₃.

23. The method of claim 22, further comprising cleaning the reflecting surface of the mirror prior to coating with the SAM.
